(19) United States
(12) Patent Application Publication
(10) Pub. No.: US 2026/0342618 A1
(43) Pub. Date: Oct. 29, 2026

(54) CAPABILITY INFORMATION REPORTING METHOD AND APPARATUS, DEVICE AND STORAGE MEDIUM

(71) Applicant: Beijing Xiaomi Mobile Software Co., Ltd., Beijing (CN)

(72) Inventors: Min LIU, Beijing (CN); Yajun ZHU, Beijing (CN)

(21) Appl. No.: 19/116,106

(22) PCT Filed: Sep. 30, 2022
(86) PCT No.: PCT/CN2022/123457

§ 371 Date: Mar. 27, 2025

(51) Int. Cl. H04L 25/02; H04W 8/22; H04W 84/06

(52) U.S. Cl. CPC H04L 25/0204; H04W 8/22; H04W 84/06

(57) ABSTRACT

A method for reporting capability information is performed by a terminal and includes: reporting capability information, wherein the capability information indicates a capability of performing joint channel estimation on at least one downlink channel in a non-terrestrial communication network (NTN).

### CROSS-REFERENCE TO RELATED APPLICATION

The present application is a U.S. National Stage of International Application No. PCT/CN2022/123457, filed on Sep. 30, 2022, the contents of which are incorporated herein by reference in their entirety.

### TECHNICAL FIELD

The present disclosure relates to the field of mobile communications and, in particular, to a capability information reporting method and apparatus, a device and a storage medium.

### BACKGROUND

In a non-terrestrial communication network (NTN) system, due to a long distance between a satellite (base station) and a ground terminal, the transmission path loss is large, which will lead to limited coverage of some downlink channels.

### SUMMARY

According to an aspect of the present disclosure, a method for reporting capability information is provided, the method is performed by a terminal, and the method includes: reporting capability information, where the capability information indicates a capability of performing joint channel estimation on at least one downlink channel in a non-terrestrial communication network (NTN).

According to another aspect of the present disclosure, a method for reporting capability information is provided, the method is performed by a network device, and the method includes: receiving capability information reported by a terminal, where the capability information indicates a capability of performing joint channel estimation on at least one downlink channel in a non-terrestrial communication network (NTN).

According to another aspect of the present disclosure, a terminal is provided, including: a processor; a transceiver connected to the processor; and a memory configured to store executable instructions of the processor; where the processor is configured to load and execute the executable instructions to report capability information, where the capability information indicates a capability of performing joint channel estimation on at least one downlink channel in a non-terrestrial communication network (NTN).

### BRIEF DESCRIPTION OF DRAWINGS

A brief introduction will be given below to the accompanying drawings of the present disclosure. It is evident that the accompanying drawings in the following description are only example embodiments of the present disclosure.

FIG. 1 is a schematic diagram of an NTN scenario based on transparent payload according to an embodiment of the present disclosure.

FIG. 2 is a schematic diagram of an NTN scenario based on regenerative payload according to an embodiment of the present disclosure.

FIG. 3 is a flowchart of a method for reporting capability information according to an embodiment of the present disclosure.

FIG. 4 is a flowchart of a method for reporting capability information according to an embodiment of the present disclosure.

FIG. 5 is a flowchart of a method for reporting capability information according to an embodiment of the present disclosure.

FIG. 6 is a schematic diagram of a TDD spectrum according to an embodiment of the present disclosure.

FIG. 7 is a schematic diagram of a FDD spectrum according to an embodiment of the present disclosure.

FIG. 8 is a structural block diagram of an apparatus for reporting capability information according to an embodiment of the present disclosure.

FIG. 9 is a structural block diagram of an apparatus for reporting capability information according to an embodiment of the present disclosure.

FIG. 10 is a schematic structural diagram of a communication device according to an embodiment of the present disclosure.

### DETAILED DESCRIPTION

A further detailed description of embodiments of the present disclosure will be provided below in conjunction with the accompanying drawings.

Reference will now be made in detail to embodiments of the present disclosure, examples of which are illustrated in the accompanying drawings. When the following description refers to the accompanying drawings, unless otherwise indicated, the same numbers in different accompanying drawings indicate the same or similar elements. Embodiments described in the following embodiments of the present disclosure do not represent all embodiments consistent with the present disclosure. Rather, they are merely examples of apparatuses and methods consistent with some aspects of the present disclosure as detailed in the appended claims.

Terms used in the present disclosure are only for a purpose of describing specific embodiments, and are not limiting the present disclosure. Singular forms of “a,” said,” and “the” used in the present disclosure and in the claims are also intended to include majority forms, unless the context clearly indicates otherwise. It should also be understood that the term “and/or” as used herein refers to any or all of the possible combinations containing one or more of the listed items in association.

It should be understood that although terms first, second, third, etc. may be used to describe various information in the present disclosure, these information should not be limited to these terms. These terms are used only to distinguish the same type of information from one another. For example, without departing from the scope of the present disclosure, first information may also be named as second information, and similarly, the second information may also be named as the first information. Depending on the context, the word “if” as used herein can be interpreted as “at” or “when” or “in response to determining”.

### Introduction to the NTN System:

At present, 3rd generation partnership project (3GPP) is studying NTN technology. Compared with a traditional Terrestrial Network (TN) system, the NTN system adopts satellite and High Altitude Platform Station (HAPS) to participate in network deployment. Taking satellite communication as an example, in theory, only a few satellites are needed to achieve global coverage except polar regions of the earth. Compared with TN system, NTN system has obvious coverage advantages. Typical application scenarios for the NTN system include situations where base stations cannot be built and base stations are damaged, such as continuous coverage in remote mountainous areas, deserts, oceans, and forests, or emergency communications in the event of a disaster or damage to a base station. The typical scenarios of NTN system can be summarized as: all-terrain coverage, signaling diversion, emergency communication, Internet of Things and broadcasting services.

The NTN system may include a satellite system. Based on satellite altitude, i.e. satellite orbital height, satellite systems can be classified into High Elliptical Orbit (HEO) satellites, Geostationary Earth Orbit (GEO) satellites, Medium-Earth Orbit (MEO) satellites, and Low-Earth Orbit (LEO) satellites. In addition, the NTN system may further include aerial network device such as a High Altitude Platform Station (HAPS) communication system, and the network device involved in the present disclosure is not limited to the above examples.

LEO satellite: LEO satellite may be named as a non-stationary satellite, and there are many kinds of non-stationary satellites. Taking LEO satellite as an example, LEO satellite moves relatively fast, at approximately 7 km/s, and thus coverage area for services provided by LEO satellites also moves with the LEO satellite. LEO satellites have short signal propagation distances and low link losses, and do not require high transmission power of user terminals.

GEO satellite: GEO satellite, also named as geostationary satellite, moves at the same speed as the Earth's rotation system, so GEO satellite remains stationary relative to the ground. Correspondingly, cells of GEO satellites are also stationary. The coverage area of a GEO satellite cell is relatively large, typically with a diameter of 500 km.

In order to ensure the coverage of communication satellites and improve the system capacity of the whole satellite communication system, communication satellites use multi-beams to cover the ground, and a communication satellite can form dozens or even hundreds of beams to cover the ground. A satellite beam can cover the ground area with a diameter of tens to hundreds of kilometers.

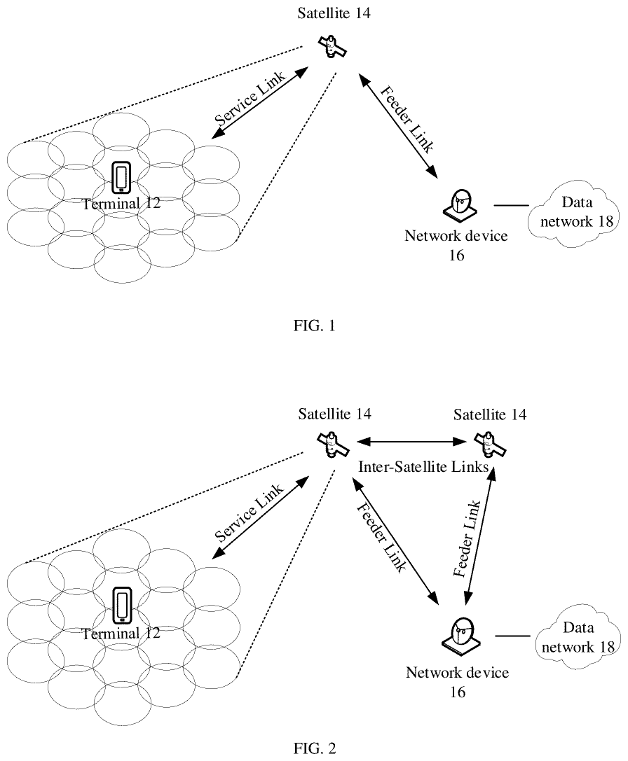

At present, there are two kinds of satellites considered by 3GPP, which are satellites with transparent payloads and satellites with regenerative payloads. FIG. 1 shows a schematic diagram of an NTN scenario based on transparent load, and FIG. 2 shows a schematic diagram of an NTN scenario based on regenerative load.

The NTN network consists of the following network elements:
One or more network devices 16: for connecting a satellite 14 with a data network 18 on the ground.
Feeder Link: a link used for communication between the network device 16 and the satellite 14.
Service Link: a link used for communication between a user terminal 12 and the satellite 14.
Satellite 14: classified into transparent payload and regenerative payload based on the functions they provide.
Transparent Payload: only provides radio frequency filtering, frequency conversion, and amplification functions. It only provides transparent signal forwarding, and will not change the transmitted waveform signal.
Regenerative Payload: in addition to providing radio frequency filtering, frequency conversion, and amplification functions, it may further provide demodulation/decoding, routing/switching, encoding/modulation functions. It has some or all functions of a base station.
Inter-Satellite Links (ISL): exist in NTN scenarios with regenerative payload.

It should be noted that the terminal in the embodiments of the present disclosure may refer to a user equipment (UE), an access terminal, a subscriber unit, a subscriber station, a mobile, a mobile station, a remote station, a remote terminal, a mobile device, a wireless communication device, a user agent or a user apparatus. In some examples, the terminal may further be a cellular phone, a cordless phone, a session initiation protocol (SIP) phone, a wireless local loop (WLL) station, a personal digital assistant (PDA), a handheld device with wireless communication function, a computing device or other processing devices connected to a wireless modem, a vehicle-mounted device, a wearable device, a terminal device in the 5th Generation System (5GS) or a terminal device in future evolved public land mobile network (PLMN), etc., which are not limited by the embodiments of the present disclosure.

The access network device in the embodiments of the present disclosure is a device deployed in an access network to provide a wireless communication function for the terminal. The access network device may include various forms of macro base stations, micro base stations, relay stations, access points and the like. In systems with different wireless access technologies, the names of devices with access network functions may be different, for example, in 5G NR systems, they are named as gNodeB or gNB. With the evolution of communication technology, the name “access network device” may change. For convenience of description, in the embodiments of the present disclosure, the apparatuses that provide wireless communication function for terminal are collectively named as access network devices. In some examples, a communication relationship can be established between the terminal and the core network device through the access network device. For example, in the long term evolution (LTE) system, the access network device may be an evolved universal terrestrial radio access network (EUTRAN) or one or more eNBs in the EUTRAN. In the 5G NR system, the access network device may be a radio access network (RAN) or one or more gNBs in the RAN.

Main functions of core network device are to provide user connection, user management and service bearing, as a bearing network to provide an interface to external networks. For example, the core network device in the 5G NR system may include an access and mobility management function (AMF) entity, a user plane function (UPF) entity, a session management function (SMF) entity, a location management function (UPF) entity, etc. The access network device and the core network device can be collectively referred to as a network device.

In the NTN system, due to a long distance between a satellite (base station) and a ground terminal, the transmission path loss is large, which will lead to limited coverage of some downlink channels.

### Introduction to Joint Channel Estimation:

Channel coverage can be improved through joint channel estimation. Joint channel estimation may include Demodulation Reference Signal (DMRS) bundling, which specifically means that a receiving end (base station) performs joint demodulation of multiple uplink channels (e.g., physical uplink shared channels) repeatedly transmitted by a transmitting end (terminal) through the DMRS of the repetition transmission of multiple uplink channels, so that the accuracy of channel estimation can be improved, and thus the coverage of uplink channels can be improved.

A prerequisite for the use of DMRS bundling is that the terminal is able to guarantee power consistency and phase continuity over a period of uplink transmission time. According to existing standards, the requirement for phase continuity (phase coherence) is met when the phase difference between two slots does not exceed 25 degrees or 30 degrees. For example, Table 1 shows a maximum allowable phase difference for DMRS bundling.

TABLE 1

| | | Phase difference between | Phase difference between |
|---|---|---|---|
| | | any slot p-1 and slot p | slot 0 and any slot p |
| | | (Phase difference | (Phase difference |
| UpLink channel | Modulation order | between any slot p- | between slot 0 and |
| (UpLink channel) | (Modulation order) | 1 and slot p) (Note 2) | any slot p) (Note 3) |
| Physical uplink | Pi/2 BPSK (binary phase | [25] degrees (degrees) | [30] degrees |
| shared channel | shift keying), QPSK | | |
| (PUSCH) | (quadrature phase shift | | |
| | keying) | | |
| PUSCH | Pi/2 BPSK, BPSK, QPSK | | |

NOTE 1:
The UE capability of the length of maximum duration refers to the maximum duration during which UE is able to meet the phase continuity requirements, assuming no phase consistency violating events defined in TS 38.214 in between.
(The UE capability of the length of maximum duration refers to the maximum duration during which UE is able to meet the phase continuity requirements, assuming no phase consistency violating events defined in TS 38.214 in between)
(Note 2):
This requirement applies for FDD (Frequency Division Duplex) and TDD (Time Division Duplex) bands, for supported DMRS bundling configurations ≤8 slots.
(This requirement applies for FDD and TDD bands, for supported DMRS bundling configurations ≤8 slots)
(Note 3):
This requirement applies only for FDD bands, for supported DMRS bundling configurations of 16 slots.
(This requirement applies only for FDD bands, for supported DMRS bundling configurations of 16 slots)

For downlink joint channel estimation, the network device (base station) needs to ensure power consistency and phase continuity in downlink transmission, and at the same time, the terminal needs to have the capability of joint channel estimation for downlink channels. The method provided in the embodiments of the present disclosure can realize the downlink joint channel estimation in the NTN system by reporting the joint channel estimation capability for at least one downlink channel in the NTN by the terminal, thereby improving the downlink channel coverage in the NTN system.

FIG. 3 shows a flowchart of a method for reporting capability information according to an embodiment of the present disclosure. The method may be performed by a terminal. The method includes:

Step 302: reporting capability information, where the capability information indicates a capability of performing joint channel estimation on at least one downlink channel in an NTN.

The terminal belongs to an NTN system, and it can report the capability information to a network device in the NTN system. The terminal and the network device in the NTN system can be referred to the examples in FIGS. 1 and 2.

In some examples, the capability information carries single-bit (1 bit) information. The single-bit information indicates whether the terminal supports the joint channel estimation on the at least one downlink channel. Or, the single-bit information indicates whether the terminal supports the joint channel estimation on a downlink repetition transmission channel within a first duration. The downlink repetition transmission channel refers to a downlink channel that has been repeatedly transmitted. In some examples, the first duration refers to a duration occupied by the downlink repetition transmission channel for repetition transmission according to a preset number of times, and the preset number of times is configured by the network device.

Or, the capability information carries multi-bit information, and the multi-bit information indicates a first duration during which the terminal supports the joint channel estimation on the at least one downlink channel. The at least one downlink channel performs repetition transmissions, and the first duration is not greater than a duration occupied by the at least one downlink channel for repetition transmission according to a preset number of times, and the preset number of times is configured by the network device. For example, the first duration is equal to a transmission duration occupied by the at least one downlink channel for repetition transmission according to the preset number of times, in which case the first duration may also be named as a maximum duration (N).

For example, when the capability information carries 3-bit information with a content of 111, it indicates that the terminal supports (or maximally supports) the joint channel estimation on the at least one downlink channel in 8 time units. In some examples, the multi-bit information is also capable of being used to indicate the number of first durations for which the terminal supports the joint channel estimation on the at least one downlink channel. For example, 3-bit information is used to indicate that the terminal supports 8 types of first durations for the joint channel estimation on the at least one downlink channel.

In some examples, a unit of the first duration includes any one of:
a slot;
a millisecond; and
the number of slots related to a subcarrier spacing (SCS).

In some examples, the capability information is reported for the at least one downlink channel. That is, for different downlink channels, the terminal can report the capability information respectively. For example, the terminal reports first capability information and second capability information, where the first capability information is reported for a Physical Downlink Shared Channel (PDCCH) and the second capability information is reported for a Physical Downlink Control Channel (PDCCH). The capability information reported by the terminal for different downlink channels may be the same or different.

In some examples, the capability information is reported for a downlink channel transmission mode. That is, for different downlink channel transmission modes, the terminal can report capability information separately, and the separately reported capability information may be the same or different. The above capability information can also be reported for types of the repetition transmissions of the at least one downlink channel. That is, for different types of repetition transmissions of the at least one downlink channel, the terminal can report capability information separately, and the separately reported capability information may be the same or different. For example, the terminal reports first capability information and second capability information, where the first capability information is reported for repetition Type A of the PDSCH, and the second capability information is reported for repetition Type B of the PDSCH. The capability information reported by the terminal for different downlink channel transmission modes may be the same or different.

After reporting the capability information to the network device, the terminal will receive a configuration duration sent by the network device, or the terminal can determine the configuration device by itself. The configuration duration is used to indicate a duration for the terminal to perform the joint channel estimation on the at least one downlink channel. This configuration duration can also be named as a Time Domain Window (TDW).

For the Case where the Network Device Explicitly Configures the Duration of the Joint Channel Estimation:

In some examples, when the capability information reported by the terminal indicates that the terminal supports the joint channel estimation on the at least one downlink channel, the network device will configure and send the configuration duration to the terminal. For example, the terminal reports to the network device that it supports the joint channel estimation for PDSCH. In this case, the network device will instruct the duration for performing the joint channel estimation for PDSCH to the terminal.

In some examples, the configuration duration (L) is not greater than (i.e., less than or equal to) the first duration, and the first duration is a duration during which the terminal supports the joint channel estimation on the at least one downlink channel, i.e., L≤N. The at least one downlink channel performs repetition transmissions, and the first duration is not greater than a duration occupied by the at least one downlink channel for repetition transmission according to a preset number of times, and the preset number of times is configured by the network device.

In some examples, the at least one downlink channel includes at least one of:
a PDSCH; or
a PDCCH.

In a case that the at least one downlink channel includes a plurality of downlink channels, the network device may send a plurality of configuration durations to the terminal, each of the plurality of configuration durations corresponds to a downlink channel, and the configuration durations corresponding to each downlink channel are the same or different. In some examples, the configuration durations sent by the network device for different downlink channels are determined according to the capability information reported by the terminal for different downlink channels.

In some examples, the configuration duration sent by the network device to the terminal is configured respectively based on a downlink bandwidth part (DL BWP), i.e., configured for per DL BWP. For example, for downlink channels in different DL BWP, the network device can configure the same or different configuration durations.

For the Case where the Terminal Determines the Duration of the Joint Channel Estimation by Itself:

In the case that the network device does not send the configuration duration to the terminal, the terminal is able to determine a minimum value between a first duration and a second duration as the configuration duration, i.e., L=min (first duration, second duration). The first duration is a duration during which the terminal supports the joint channel estimation on the at least one downlink channel. The at least one downlink channel performs repetition transmissions, and the first duration is not greater than a duration occupied by the at least one downlink channel for repetition transmission according to a preset number of times. The second duration may be named as a maximum repetition transmission duration, which specifically refers to a duration occupied by the at least one downlink channel for repetition transmission according to the preset number of times, and the preset number of times is configured by the network device.

For example, the preset number of repetition transmissions of the at least one downlink channel is 8 times, and a duration occupied by the at least one downlink channel when performing repetition transmissions according to 8 times is 9 time units, i.e., the second duration is 9 time units. The terminal supports the joint channel estimation on the at least one downlink channel in 8 time units, i.e., the first duration is 8 time units. In this case, the configuration duration determined by the terminal itself is 8 time units.

After determining the configuration duration, the terminal will determine an actual time window for performing joint channel estimation on the at least one downlink channel and performs joint channel estimation on the at least one downlink channel within the time window. In some examples, in a case that the at least one downlink channel includes a plurality of downlink channels, the terminal performs joint channel estimation on the downlink channels respectively in the same or different time windows.

The above for the case where the network device explicitly configures the duration of the joint channel estimation and/or for the case where the terminal determines the duration of the joint channel estimation by itself, can only determine the nominal duration for the terminal to perform downlink joint channel estimation. The actual duration for the terminal to perform the downlink joint channel estimation depends on specific conditions.

### For the Case of Time Division Duplexing (TDD) Systems:

(1) The terminal determines a time window according to a configuration duration.

The terminal can determine a time window for the terminal to perform the joint channel estimation on the at least one downlink channel at least according to the configuration duration. In some examples, the terminal determines the time window for the terminal to perform the joint channel estimation on the at least one downlink channel according to a TDD configuration and the configuration duration. The TDD configuration includes a corresponding relationship between different time units and channels they transmit. For example, in the configuration duration, if the TDD configuration indicates that a certain time unit is used for transmitting through an uplink channel, the terminal does not perform a joint channel estimation on the channel transmitting in the time cell. And the calculation starts from the next downlink channel, and the calculation duration does not exceed TDW.

(2) The terminal determines a time window by itself.

The terminal can also determine the time window for performing joint channel estimation on the at least one downlink channel by itself. In some examples, the terminal determines the time window for the terminal to perform the joint channel estimation on the at least one downlink channel according to the TDD configuration. The actual number of consecutive time units on which the terminal performs joint channel estimation depends on the implementation of the terminal and is not standardized. The TDD configuration includes a corresponding relationship between different time units and channels they transmit. For example, if the TDD configuration indicates that a certain time unit is used for transmitting through an uplink channel, the terminal does not perform a joint channel estimation on the channel transmitting in the time cell.

In some examples, the time window includes at least one of following information:
a start position;
an end position; or
a time span.

In some examples, the start position refers to a position of the time unit when the terminal starts performing the joint channel estimation, the end position refers to a position of the time unit when the terminal ends performing the joint channel estimation, and the time span refers to the number of time units occupied by the terminal performing the joint channel estimation. In some examples, when determining the time window, the terminal will also consider the first duration supported by itself for performing the joint channel estimation on the at least one downlink channel.

### For the Case of Frequency Division Duplexing (FDD) Systems:

In an FDD system, the terminal will perform joint channel estimation on the at least one downlink channel within a configuration duration starting from the moment when the terminal first receives a repeatedly transmitted downlink channel. That is, in the FDD system, a length of the time window determined by the terminal is the configuration duration, and the starting position is the moment when the terminal first receives the repeatedly transmitted downlink channel.

In some examples, during the process of performing joint channel estimation on the at least one downlink channel in the FDD system, the terminal will terminate to perform the joint channel estimation on the at least one downlink channel when at least one of following conditions is met:
detection of a predefined termination event; or
end of repetition transmissions of the at least one downlink channel.

For example, the termination event includes discarding or canceling transmission of the at least one downlink channel due to collision rules.

To sum up, the method provided in the embodiments of the present disclosure can realize the downlink joint channel estimation in the NTN system by reporting the joint channel estimation capability for the at least one downlink channel in the NTN by the terminal, thereby improving the downlink channel coverage in the NTN system.

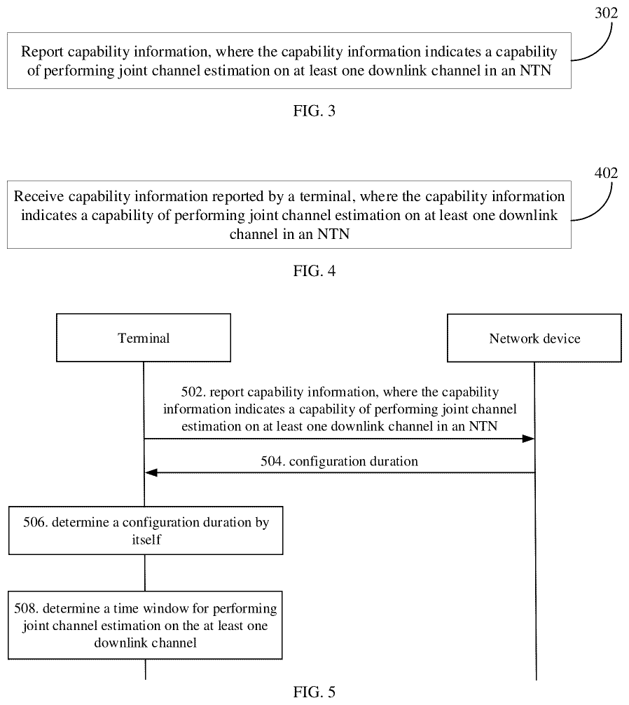

FIG. 4 shows a flowchart of a method for reporting capability information according to an embodiment of the present disclosure. The method may be performed by a network device.

The method includes:

Step 402: receiving capability information reported by a terminal, where the capability information indicates a capability of performing joint channel estimation on at least one downlink channel in an NTN.

The terminal belongs to an NTN system, and it can report the capability information to a network device in the NTN system. The terminal and the network device in the NTN system can be referred to the examples in FIGS. 1 and 2.

In some examples, the capability information carries single-bit information. The single-bit information indicates whether the terminal supports the joint channel estimation on the at least one downlink channel. Or, the single-bit information indicates whether the terminal supports the joint channel estimation on a downlink repetition transmission channel within a first duration. The downlink repetition transmission channel refers to a downlink channel that has been repeatedly transmitted. In some examples, the first duration refers to a duration occupied by the downlink repetition transmission channel for repetition transmission according to a preset number of times, and the preset number of times is configured by the network device. Or, the capability information carries multi-bit information, and the multi-bit information indicates the first duration during which the terminal supports the joint channel estimation on the at least one downlink channel. The first duration is not greater than a duration occupied by the at least one downlink channel for repetition transmission according to a preset number of times. In the case where the first duration is equal to a transmission duration occupied by the at least one downlink channel for repetition transmission according to the preset number of times, the first duration may also be named as a maximum duration (N).

In some examples, a unit of the first duration includes any one of:
a slot;
a millisecond; and
the number of slots related to a subcarrier spacing (SCS).

In some examples, the capability information is reported for the at least one downlink channel. That is, for different downlink channels, the terminal can report the capability information respectively. The capability information reported by the terminal for different downlink channels may be the same or different. In some examples, the capability information is reported for a downlink channel transmission mode. That is, for different downlink channel transmission modes, the terminal can report capability information separately, and the separately reported capability information may be the same or different. The above capability information can also be reported for types of the repetition transmissions of the at least one downlink channel. That is, for different types of repetition transmissions of the at least one downlink channel, the terminal can report capability information separately, and the separately reported capability information may be the same or different.

After receiving the capability information reported by the terminal, the network device will configure the terminal and send the configuration duration. In some examples, the terminal can also determine the configuration duration by itself. The configuration duration is used to indicate a duration for the terminal to perform the joint channel estimation on the at least one downlink channel.

In some examples, if the capability information reported by the terminal indicates that the terminal supports the joint channel estimation on the at least one downlink channel, the network device will configure and send the configuration duration to the terminal. For example, the terminal reports to the network device that it supports the joint channel estimation for PDSCH. In this case, the network device will instruct the duration for performing the joint channel estimation for PDSCH to the terminal.

In some examples, the configuration duration (L) is less than or equal to the first duration, and the first duration is a duration during which the terminal supports the joint channel estimation on the at least one downlink channel, i.e., L≤N. The at least one downlink channel performs repetition transmissions, and the first duration is not greater than a duration occupied by the at least one downlink channel for repetition transmission according to a preset number of times, and the preset number of times is configured by the network device.

In some examples, the at least one downlink channel includes at least one of:
a PDSCH; or
a PDCCH.

In a case that the at least one downlink channel includes a plurality of downlink channels, the network device may send a plurality of configuration durations to the terminal, each of the plurality of configuration durations corresponds to a downlink channel, and the configuration durations corresponding to each downlink channel are the same or different. In some examples, the configuration durations sent by the network device for different downlink channels are determined according to the capability information reported by the terminal for different downlink channels.

In some examples, the configuration duration sent by the network device to the terminal is based on per DL BWP configuration. For example, for downlink channels in different DL BWP, the network device can configure the same or different configuration durations.

After receiving the configuration duration, the terminal will determine an actual time window for performing joint channel estimation on the at least one downlink channel and performs joint channel estimation on the at least one downlink channel within the time window.

To sum up, the method provided in the embodiments of the present disclosure can realize the downlink joint channel estimation in the NTN system by reporting the joint channel estimation capability for the at least one downlink channel in the NTN by the terminal, thereby improving the downlink channel coverage in the NTN system.

FIG. 5 shows a flowchart of a method for reporting capability information according to an embodiment of the present disclosure. The method may be performed by a system shown in FIG. 1 or 2. The method includes:

Step 502: the terminal reports capability information, where the capability information indicates a capability of performing joint channel estimation on at least one downlink channel in an NTN.

The terminal belongs to an NTN system, and it can report the capability information to a network device in the NTN system. The terminal and the network device in the NTN system can be referred to the examples in FIGS. 1 and 2.

In some examples, the capability information carries single-bit (1 bit) information. The single-bit information indicates whether the terminal supports the joint channel estimation on the at least one downlink channel. Or, the single-bit information indicates whether the terminal supports the joint channel estimation on a downlink repetition transmission channel within a first duration. The downlink repetition transmission channel refers to a downlink channel that has been repeatedly transmitted. In some examples, the first duration refers to a duration occupied by the downlink repetition transmission channel for repetition transmission according to a preset number of times, and the preset number of times is configured by the network device.

Or, the capability information carries multi-bit information, and the multi-bit information indicates the first duration during which the terminal supports the joint channel estimation on the at least one downlink channel. The at least one downlink channel performs repetition transmissions, and the first duration is not greater than a duration occupied by the at least one downlink channel for repetition transmission according to a preset number of times, and the preset number of times is configured by the network device. For example, the first duration is equal to a transmission duration occupied by the at least one downlink channel for repetition transmission according to the preset number of times, in which case the first duration may also be named as a maximum duration (N).

For example, when the capability information carries 3-bit information with a content of 111, it indicates that the terminal supports the joint channel estimation on the at least one downlink channel in 8 time units. In some examples, the multi-bit information is also capable of being used to indicate the number of first durations for which the terminal supports the joint channel estimation on the at least one downlink channel. For example, 3-bit information is used to indicates that the terminal supports 8 types of first duration for the joint channel estimation on the at least one downlink channel.

In some examples, a unit of the first duration includes any one of:
a slot;
a millisecond; and
the number of slots related to a subcarrier spacing (SCS).

In some examples, the capability information is reported for the at least one downlink channel. That is, for different downlink channels, the terminal can report the capability information respectively. For example, the terminal reports first capability information and second capability information, where the first capability information is reported for the PDSCH, and the second capability information is reported for the PDCCH. The capability information reported by the terminal for different downlink channels may be the same or different.

In some examples, the capability information is reported for a downlink channel transmission mode. That is, for different downlink channel transmission modes, the terminal can report capability information separately, and the separately reported capability information may be the same or different. The above capability information can also be reported for types of the repetition transmissions of the at least one downlink channel. That is, for different types of repetition transmissions of the at least one downlink channel, the terminal can report capability information separately, and the separately reported capability information may be the same or different. For example, the terminal reports first capability information and second capability information, where the first capability information is reported for repetition Type A of the PDSCH, and the second capability information is reported for repetition Type B of the PDSCH. The capability information reported by the terminal for different downlink channel transmission modes may be the same or different.

Step 504: the network device sends a configuration duration to the terminal.

The configuration duration is used to indicate a duration for the terminal to perform the joint channel estimation on the at least one downlink channel. The configuration duration can also be named as TDW. In some examples, if the capability information reported by the terminal indicates that the terminal supports the joint channel estimation on the at least one downlink channel, the network device will configure and send the configuration duration to the terminal. For example, the terminal reports to the network device that it supports the joint channel estimation for PDSCH. In this case, the network device will instruct the duration for performing the joint channel estimation for PDSCH to the terminal.

In some examples, the configuration duration (L) is less than or equal to the first duration, and the first duration is a duration during which the terminal supports the joint channel estimation on the at least one downlink channel, i.e., L≤N. The at least one downlink channel performs repetition transmissions, and the first duration is not greater than a duration occupied by the at least one downlink channel for repetition transmission according to a preset number of times, and the preset number of times is configured by the network device.

In some examples, the at least one downlink channel includes at least one of:
a PDSCH; or
a PDCCH.

In a case that the at least one downlink channel includes a plurality of downlink channels, the network device may send a plurality of configuration durations to the terminal, each of the plurality of configuration durations corresponds to a downlink channel, and the configuration durations corresponding to each downlink channel are the same or different. In some examples, the configuration durations sent by the network device for different downlink channels are determined according to the capability information reported by the terminal for different downlink channels.

In some examples, the configuration duration sent by the network device to the terminal is respectively configured based on DL BWP, i.e., configured for per DL BWP. For example, for downlink channels in different DL BWP, the network device can configure the same or different configuration durations.

Step 506: the terminal determines a configuration duration by itself.

In the case that the network device does not send the configuration duration to the terminal, the terminal is able to determine a minimum value between a first duration and a second duration as the configuration duration, i.e., L=min (first duration, second duration). The first duration is a duration during which the terminal supports the joint channel estimation on the at least one downlink channel. The at least one downlink channel performs repetition transmissions, and the first duration is not greater than a duration occupied by the at least one downlink channel for repetition transmission according to a preset number of times. The second duration may be named as a maximum repetition transmission duration, which specifically refers to a duration occupied by the at least one downlink channel for repetition transmission according to the preset number of times, and the preset number of times is configured by the network device.

Step 508: the terminal determines a time window for performing joint channel estimation on the at least one downlink channel.

In some examples, in a case that the at least one downlink channel includes a plurality of downlink channels, the terminal performs joint channel estimation on the downlink channels respectively in the same or different time windows.

The above for the case where the network device explicitly configures the duration of the joint channel estimation and/or for the case where the terminal determines the duration of the joint channel estimation by itself, can only determine the nominal duration for the terminal to perform downlink joint channel estimation. The actual duration for the terminal to perform the downlink joint channel estimation depends on specific conditions.

### For the Case of TDD Systems:

(1) The terminal determines a time window according to a configuration duration.

The terminal can determine a time window for the terminal to perform the joint channel estimation on the at least one downlink channel at least according to the configuration duration. In some examples, the terminal determines the time window for the terminal to perform the joint channel estimation on the at least one downlink channel according to a TDD configuration and the configuration duration. The TDD configuration includes a corresponding relationship between different time units and channels they transmit. For example, in the configuration duration, if the TDD configuration indicates that a certain time unit is used for transmitting through an uplink channel, the terminal does not perform a joint channel estimation on the channel transmitting in the time cell. And the calculation starts from the next downlink channel, and the calculation duration does not exceed TDW.

(2) The terminal determines a time window by itself.

The terminal can also determine the time window for performing joint channel estimation on the at least one downlink channel by itself. In some examples, the terminal determines the time window for the terminal to perform the joint channel estimation on the at least one downlink channel according to the TDD configuration. The actual number of consecutive time units on which the terminal performs joint channel estimation depends on the implementation of the terminal and is not standardized. The TDD configuration includes a corresponding relationship between different time units and channels they transmit. For example, if the TDD configuration indicates that a certain time unit is used for transmitting through an uplink channel, the terminal does not perform a joint channel estimation on the channel transmitting in the time cell.

In some examples, the time window includes at least one of following information:
a start position;
an end position; or
a time span.

In some examples, the start position refers to a position of the time unit when the terminal starts performing the joint channel estimation, the end position refers to a position of the time unit when the terminal ends performing the joint channel estimation, and the time span refers to the number of time units occupied by the terminal performing the joint channel estimation. In some examples, when determining the time window, the terminal will also consider the first duration supported by itself for performing the joint channel estimation on the at least one downlink channel.

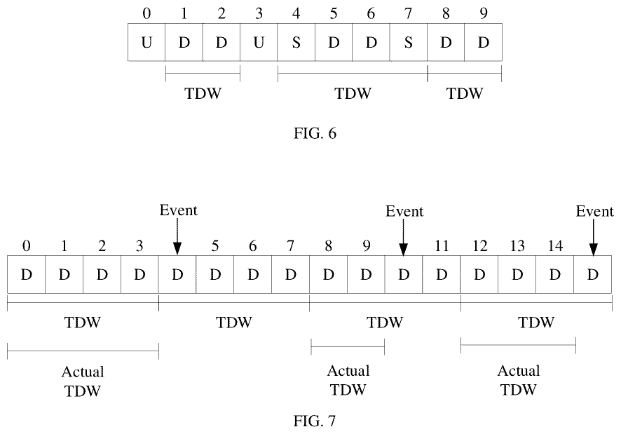

For example, FIG. 6 is a schematic diagram of a TDD spectrum according to an embodiment of the present disclosure. As shown in FIG. 6, U in the frequency spectrum represents downlink transmission and D represents uplink transmission. In a TDD system, the configuration duration L=4, and the number of repetition transmissions of the downlink channel is 8 (in the TDD system, the repetition transmission of PDSCH is skipped if it meets the uplink transmission, but the number of repetition transmissions is still counted). The repetition transmissions of the downlink channel start at slot 1 (or a symbol within slot 1) and continue until slot 9. The length of the time window (actual TDW) for joint channel estimation determined by the terminal is 4. In this case, the terminal performs joint channel estimation in slots 1 and 2, slot 3 is skipped for the uplink, and then performs joint channel estimation in slots 4 to 7. Although slots 8 and 9 also involve downlink repetition transmissions, continuing joint channel estimation beyond slots 4-7 would exceed the length of the time window, so the terminal only performs joint channel estimation in slots 4-7. After that, joint channel estimation is performed in slot8 and slot9.

### For the Case of FDD Systems:

In an FDD system, the terminal will perform joint channel estimation on the at least one downlink channel within a configuration duration starting from the moment when the terminal first receives a repeatedly transmitted downlink channel. That is, in the FDD system, a length of the time window determined by the terminal is the configuration duration, and the starting position is the moment when the terminal first receives the repeatedly transmitted downlink channel. In some examples, the moment when the terminal receives the repeatedly transmitted downlink channel refers to a slot or a time domain symbol in which the terminal receives the repeatedly transmitted downlink channel.

In some examples, during the process of performing joint channel estimation on the at least one downlink channel in the FDD system, the terminal will terminate to perform the joint channel estimation on the at least one downlink channel when at least one of following conditions is met:
detection of a predefined termination event; or
end of repetition transmissions of the at least one downlink channel.

For example, the termination event includes discarding or canceling transmission of the at least one downlink channel due to collision rules.

For example, FIG. 7 is a schematic diagram of a FDD spectrum according to an embodiment of the present disclosure. As shown in FIG. 7, U in the frequency spectrum represents downlink transmission and D represents uplink transmission. In a FDD system, the configuration duration L=4, and the number of repetition transmissions of the downlink channel is 15. The repetition transmissions of the downlink channel start at slot 1 (or a symbol within slot 1) and continue until slot 15, with the terminal first receiving the repeatedly transmitted downlink channel in slot 1. In this case, the terminal performs joint channel estimation in slot0-slot3. Since a termination event is detected in slot 4, the terminal skips slots 4-7 without performing joint channel estimation. After that, the terminal performs joint channel estimation in slot8 and slot9, since the termination event is detected in slot10, the terminal will skip slot10 and slot11. After that, the terminal performs joint channel estimation in slot12-slot14, and since a termination event is detected in slot15, the terminal will end the joint channel estimation.

It should be noted that the above steps 504 and 506 are parallel steps, that is, when the method provided by this embodiment is executed, only one of the steps 504 and 506 is executed.

In some examples, the duration reported by the terminal and the duration configured by the network device in the embodiments of the present disclosure are configured in a specific manner or in other ways. For example, by bit and code point configuration. The corresponding duration can be determined by combining information such as bits and code points with preset information.

To sum up, the method provided in the embodiments of the present disclosure can realize the downlink joint channel estimation in the NTN system by reporting the joint channel estimation capability for the at least one downlink channel in the NTN by the terminal, thereby improving the downlink channel coverage in the NTN system.

It should be noted that the sequence of the method steps provided by the embodiments of the present disclosure can be adjusted appropriately, and the steps can be increased or decreased accordingly according to the situation. Any person familiar with the technical field can easily think of changing methods within the technical scope disclosed in the present disclosure, which should be covered by the protection scope of the present disclosure, so they are not repeated here.

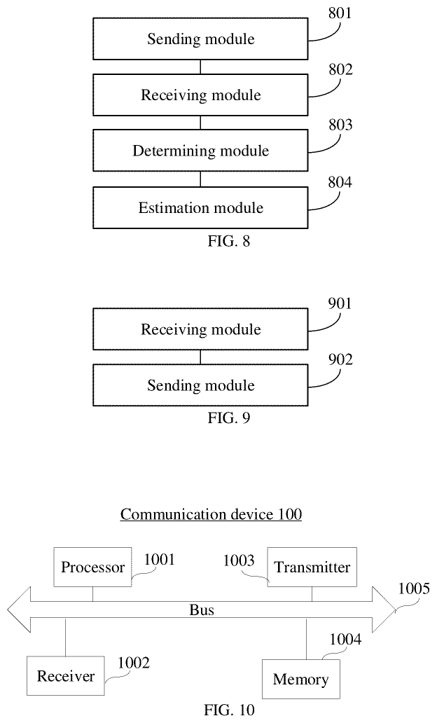

FIG. 8 shows a structural block diagram of an apparatus for reporting capability information according to an embodiment of the present disclosure. As shown in FIG. 8, the apparatus include:
a sending module 801, configured to report capability information, where the capability information indicates a capability of performing joint channel estimation on at least one downlink channel in a non-terrestrial communication network (NTN).

In an example, the capability information carries single-bit information, where the single-bit information indicates whether the apparatus supports the joint channel estimation on the at least one downlink channel; or, the single-bit information indicates whether the apparatus supports the joint channel estimation on a downlink repetition transmission channel within a first duration.

In an example, the capability information carries multi-bit information, and the multi-bit information indicates a first duration during which the apparatus supports the joint channel estimation on the at least one downlink channel.

In an example, a unit of the first duration includes any one of:
a slot;
a millisecond; and
the number of slots related to a subcarrier spacing (SCS).

In an example, the apparatus further includes:
a receiving module 802, configured to receive a configuration duration sent by a network device;
where the configuration duration is used to indicate a duration for the apparatus to perform the joint channel estimation on the at least one downlink channel.

In an example, the configuration duration is less than or equal to a first duration during which the apparatus supports the joint channel estimation on the at least one downlink channel.

In an example, the at least one downlink channel includes at least one of:
a PDSCH; or
a PDCCH.

In an example, in a case that the at least one downlink channel includes a plurality of downlink channels, the configuration duration corresponding to each of the plurality of downlink channels is different.

In an example, the configuration duration is configured respectively based on a DL BWP.

In an example, the apparatus further includes:
a determining module 803, configured to determine a minimum value of a first duration and a second duration as the configuration duration,
where the first duration is a duration during which the apparatus supports the joint channel estimation on the at least one downlink channel, and the second duration is a duration occupied by the at least one downlink channel for a preset number of repetition transmissions.

In an example, the apparatus further includes:
a determining module 803, configured to determine, at least according to the configuration duration, a time window for the apparatus to perform the joint channel estimation on the at least one downlink channel.

In an example, the determining module 803 is configured to:
determine, according to a TDD configuration and the configuration duration, the time window for the apparatus to perform the joint channel estimation on the at least one downlink channel.

In an example, the apparatus further includes:
a determining module 803, configured to determine a time window for the apparatus to perform the joint channel estimation on the at least one downlink channel.

In an example, the determining module 803 is configured to:
determine, according to a TDD configuration, the time window for the apparatus to perform the joint channel estimation on the at least one downlink channel.

In an example, the time window includes at least one of following information:
a start position;
an end position; or
a time span.

In an example, the apparatus further includes:
an estimation module 804, configured to, in a frequency division duplex (FDD) system, starting from a moment when the apparatus first receives a repetition transmission of the at least one downlink channel, perform the joint channel estimation on the at least one downlink channel within the configuration duration.

In an example, the estimation module 804 is configured to:
terminate to perform the joint channel estimation on the at least one downlink channel when at least one of following conditions is met:
detection of a predefined termination event; or
end of repetition transmissions of the at least one downlink channel.

In an example, the capability information is reported for the at least one downlink channel.

FIG. 9 shows a structural block diagram of an apparatus for reporting capability information according to an embodiment of the present disclosure. As shown in FIG. 9, the apparatus include:
a receiving module 901, configured to receive capability information reported by a terminal, where the capability information indicates a capability of performing joint channel estimation on at least one downlink channel in a non-terrestrial communication network (NTN).

In an example, the capability information carries single-bit information, where the single-bit information indicates whether the terminal supports the joint channel estimation on the at least one downlink channel; or, the single-bit information indicates whether the terminal supports the joint channel estimation on a downlink repetition transmission channel within a first duration.

In an example, the capability information carries multi-bit information, and the multi-bit information indicates a first duration during which the terminal supports the joint channel estimation on the at least one downlink channel.

In an example, a unit of the first duration includes any one of:
a slot;
a millisecond; and
the number of slots related to a subcarrier spacing (SCS).

In an example, the apparatus further includes:
a sending module 902, configured to send a configuration duration to the terminal;
where the configuration duration is used to indicate a duration for the terminal to perform the joint channel estimation on the at least one downlink channel.

In an example, the configuration duration is less than or equal to a first duration during which the terminal supports the joint channel estimation on the at least one downlink channel.

In an example, the at least one downlink channel includes at least one of:
a PDSCH; or
a PDCCH.

In an example, in a case that the at least one downlink channel includes a plurality of downlink channels, the configuration duration corresponding to each of the plurality of downlink channels is different.

In an example, the configuration duration is configured respectively based on a DL BWP.

In an example, the capability information is reported for the at least one downlink channel.

It should be noted that when the apparatus provided in the above embodiment realizes its functions, it only takes the division of the above-mentioned functional modules as an example. In practical application, the above-mentioned function allocation can be completed by different functional modules according to actual needs, that is, the content structure of the apparatus is divided into different functional modules to complete all or part of the above-mentioned functions.

Regarding to the apparatus in the above embodiment, a specific way in which each module performs operations has been described in detail in the embodiments relating to the method, and will not be described in detail here.

FIG. 10 shows a schematic structural diagram of a communication device according to an embodiment of the present disclosure. The communication device 100 includes a processor 1001, a receiver 1002, a transmitter 1003, a memory 1004 and a bus 1005.

The processor 1001 includes one or more processing cores, and the processor 1001 executes various functional applications and information processing by running software programs and modules.

The receiver 1002 and the transmitter 1003 may be implemented as a communication component, which may be a communication chip.

The memory 1004 is connected to the processor 1001 through a bus 1005.

The memory 1004 may be used to store the at least one instruction, and the processor 1001 is configured to execute the at least one instruction to implement the various steps in the method embodiments described above.

In addition, the memory 1004 may be implemented by any type of volatile or non-volatile storage device or a combination thereof, volatile or non-volatile storage devices including, but not limited to: a disk or optical disk, an electrically erasable programmable Read Only Memory (EEPROM), an Erasable Programmable Read Only Memory (EPROM), a Static Random Access Memory (SRAM), a Read-Only Memory (ROM), a Magnetic Memory, a Flash Memory, and a Programmable Read Only Memory (PROM).

When the communication device is implemented as a terminal, the processor and the transceiver in the communication device according to the embodiment of the present disclosure may be implemented as a communication chip together, or the transceiver may be formed as a communication chip separately. Where, the transmitter in the transceiver executes the sending step executed by the terminal in any of the above-mentioned methods, the receiver in the transceiver executes the receiving step executed by the terminal in any of the above-mentioned methods, and the processor executes the steps other than the sending and receiving steps, which are not described in detail here.

When the communication device is implemented as a network device, the processor and the transceiver in the communication device according to the embodiment of the present disclosure may be implemented as a communication chip together, or the transceiver may be formed as a communication chip separately. Where, the transmitter in the transceiver executes the sending step executed by the network device in any of the above-mentioned methods, the receiver in the transceiver executes the receiving step executed by the network device in any of the above-mentioned methods, and the processor executes the steps other than the sending and receiving steps, which are not described in detail here.

In an embodiment, a computer-readable storage medium is further provided, in which at least one instruction, at least one program, a code set or an instruction set is stored, and the at least one instruction, the at least one program, the code set or the instruction set are loaded and executed by the processor to realize the method for reporting capability information provided by the above method embodiments.

In an embodiment, a chip is further provided, which includes a programmable logic circuit and/or program instructions, and when the chip runs on a communication device, it is configured to realize the method for reporting capability information provided by the above method embodiments.

In an embodiment, a computer program product is further provided, which, when run on a processor of a computer device, causes the computer device to execute the above-mentioned method for reporting capability information.

Those skilled in the art should realize that in one or more of the above examples, the functions described in the embodiments of the present disclosure can be realized by hardware, software, firmware or any combination thereof. When implemented in software, these functions can be stored in a computer-readable medium or transmitted as one or more instructions or codes on a computer-readable medium. Computer-readable media include computer storage media and communication media, where communication media includes any media that facilitates the transfer of computer programs from one place to another. The storage medium may be any available medium that can be accessed by a general-purpose or special-purpose computer.

The above is only example embodiments of the present disclosure, and are not used to limit the present disclosure. Any modification, equivalent substitution, improvement made within the spirit and principle of the present disclosure should be included in the protection scope of the present disclosure.

1. A method for reporting capability information, performed by a terminal and comprising:
reporting capability information, wherein the capability information indicates a capability of performing joint channel estimation on at least one downlink channel in a non-terrestrial communication network (NTN).

2. The method according to claim 1, wherein the capability information carries single-bit information;
wherein the single-bit information indicates; whether the terminal supports the joint channel estimation on the at least one downlink channel, or whether the terminal supports joint channel estimation on a downlink repetition transmission channel within a first duration.

3. The method according to claim 1, wherein the capability information carries multi-bit information, and the multi-bit information indicates a first duration during which the terminal supports the joint channel estimation on the at least one downlink channel.

4. (canceled)

5. The method according to claim 1, further comprising:
receiving a configuration duration sent by a network device,
wherein the configuration duration indicates a duration for the terminal to perform the joint channel estimation on the at least one downlink channel.

6. The method according to claim 5, wherein the configuration duration is less than or equal to a first duration during which the terminal supports the joint channel estimation on the at least one downlink channel.

7. (canceled)

8. (canceled)

9. The method according to claim 5, wherein the configuration duration is configured respectively based on a downlink bandwidth part (DL BWP);
wherein in a case that the at least one downlink channel comprises a plurality of downlink channels, the configuration duration corresponding to each of the plurality of downlink channels is different.

10. The method according to claim 5, further comprising:
determining a minimum value of a first duration and a second duration as the configuration duration,
wherein the first duration is a duration during which the terminal supports the joint channel estimation on the at least one downlink channel, and the second duration is a duration occupied by the at least one downlink channel for a preset number of repetition transmissions.

11. The method according to claim 5, further comprising one of:
determining, according to the configuration duration, a time window for the terminal to perform the joint channel estimation on the at least one downlink channel;
determining, according to a time division duplexing (TDD) configuration and the configuration duration, the time window for the terminal to perform the joint channel estimation on the at least one downlink channel; or
determining, according to the TDD configuration, the time window for the terminal to perform the joint channel estimation on the at least one downlink channel.

12.-14. (canceled)

15. The method according to claim 11, wherein the time window comprises at least one of:
a start position;
an end position; or
a time span.

16. The method according to claim 5, further comprising:
in a frequency division duplex (FDD) system, starting from a moment when the terminal first receives a repetition transmission of the at least one downlink channel, performing the joint channel estimation on the at least one downlink channel within the configuration duration.

17. The method according to claim 16, further comprising:
terminating to perform the joint channel estimation on the at least one downlink channel when at least one of following conditions is met:
detection of a predefined termination event; or
end of repetition transmissions of the at least one downlink channel.

18. The method according to claim 1, wherein the capability information is reported for the at least one downlink channel.

19. A method for reporting capability information, performed by a network device and comprising:
receiving capability information reported by a terminal, wherein the capability information indicates a capability of performing joint channel estimation on at least one downlink channel in a non-terrestrial communication network (NTN).

20. The method according to claim 19, wherein the capability information carries single-bit information;
wherein the single-bit information indicates; whether the terminal supports the joint channel estimation on the at least one downlink channel, or whether the terminal supports the joint channel estimation on a downlink repetition transmission channel within a first duration.

21. The method according to claim 19, wherein the capability information carries multi-bit information, and the multi-bit information indicates a first duration during which the terminal supports the joint channel estimation on the at least one downlink channel.

22. (canceled)

23. The method according to claim 19, further comprising:
sending a configuration duration to the terminal;
wherein the configuration duration indicates a duration for the terminal to perform the joint channel estimation on the at least one downlink channel.

24. The method according to claim 23, wherein the configuration duration is less than or equal to a first duration during which the terminal supports the joint channel estimation on the at least one downlink channel.

25. (canceled)

26. (canceled)

27. The method according to claim 23, wherein the configuration duration is configured respectively based on a downlink bandwidth part (DL BWP);
wherein in a case that the at least one downlink channel comprises a plurality of downlink channels, the configuration duration corresponding to each of the plurality of downlink channels is different.

28.-30. (canceled)

31. A terminal, comprising:
a processor;
a transceiver connected to the processor; and
a memory configured to store executable instructions of the processor;
wherein the processor is configured to:
report capability information, wherein the capability information indicates a capability of performing joint channel estimation on at least one downlink channel in a non-terrestrial communication network (NTN).

32. A network device, comprising:
a processor;
a transceiver connected to the processor; and
a memory configured to store executable instructions of the processor;
wherein the processor is configured to perform the method according to claim 19.

33. (canceled)

34. (canceled)
